(19) United States
(12) Patent Application Publication
(10) Pub. No.: US 2012/0079707 A1
(43) Pub. Date: Apr. 5, 2012

(54) Tongue-in-groove floor and wall

(76) Inventor: Ziming Shen, Staten Island, NY (US)

(21) Appl. No.: 13/134,981

(22) Filed: Jun. 22, 2011

Related U.S. Application Data
(63) Continuation-in-part of application No. 12/386,825, filed on Apr. 23, 2009, now abandoned.
Application No. 12/386,825 is a continuation-in-part of application No. 12/380,928, filed on Mar. 4, 2009.

(51) Int. Cl. B23P 17/04

(52) U.S. Cl. 29/521

(57) ABSTRACT

A method of making a set of interlocking floor or wall panels includes providing a single solid layer with a veneer layer on top. The fabrication method involves the use of edge routing using a tongue cutter on one edge and a groove cutter on the opposite edge to form the edge shapes equivalent to those of the previous embodiment. If two routing heads are spaced apart the appropriate distance for a particular sized panel, a single pass can form a tongue on one edge and a groove on the opposite edge simultaneously. One cutter is spun clockwise while the second is spun counterclockwise to equalize the forces on the panel. Thus two passes are needed to form the edges of a panel. The veneer layer, which may be bamboo, birch, or other woods such as cherry wood, is adhesively bonded to the top surface.

### RELATED APPLICATIONS

This application in part discloses and claims subject matter disclosed in my earlier filed patent application Ser. No. 12/386,825, filed on Apr. 23, 2009. This application also discloses and claims subject matter disclosed in my earlier filed patent application Ser. No. 12/380,928, filed on Mar. 4, 2009. These applications are incorporated by reference herein. Applicant claims priority under 35 USC §120 therefrom.

### FIELD OF THE INVENTION

The present invention relates to tongue and groove floor, ceiling and wall panels sculpted out of a single piece of wood or other material, with a veneer atop each panel.

### BACKGROUND OF THE INVENTION

Floor panels, such as parquet floor panels, are typically made of an array of interlocking tongue and groove panels. However, often the grooves are gouged out of a single piece of wood, and the corresponding tongues are sculpted out of a single piece of wood, making their manufacture time consuming and subject to minute, small errors.

U.S. Pat. No. 2,257,048 of Fulbright describes a panel with multiple layers glued together.

The flooring of Martensson in his U.S. Pat. No. 6,101,778, uses a solid base layer with bonded profiled edges providing snap-together profiles. U.S. Pat. No. 2,283,135 of Bruce for flooring uses solid strips of wood with no veneer upper layer. The flooring of Martensson in his U.S. Pat. No. 6,101,778, uses a solid base layer with bonded profiled edges providing snap-together profiles. However, Martensson '778 requires coupling the respective tongue 7 and groove 6 to respective separate panels 1, each respective panel 1 having respective lower portions 15 which mate with corresponding flanges 16 and 14 extending respectively from tongue 7 and groove 6.

U.S. Pat. No. 2,283,135 of Bruce for flooring uses solid strips of wood with no veneer upper layer. Bruce 135 also uses nails 10 to attach elongated strips 1 to subflooring, a feature not required by Applicant's interlocking panels.

Martensson '778 therefore uses the idea of one side clamping to the other side, Martensson '778 also uses long panels, not interlocking square panels like the Applicant herein. Martensson '778 does not describe a system where oppositely located, coordinated rotating bits can sculpt not only the tongue and grooves of wall panels from solid blocks, and Martensson cannot sculpt panel edges by rounding or texturing them. Martensson does not describe using coordinated pairs of rotating bits that changes the surface topography of wall panels to the designer's liking and preferences. Martensson '778 does not describe a method of simultaneously cutting opposing sides of a floor panel at the same time, which would make the panels more uniform in structure.

### OBJECTS OF THE INVENTION

It is therefore an object of the present invention to provide tongue and groove floor, ceiling and wall panels using multiple bonded sheet construction, with minimal or no gouging or sculpting of pieces of wood.

It is also an object to provide a panel made up of three sheets of substantially the same equal thickness, and to form respective protruding tongues and receptacle grooves from overlapping of the substantially equal thick sheets forming the panel.

It is also an object of the present invention to provide a relatively tight fit of the tongue portions into the respective groove portions of the assembled sheets forming each panel.

It is also an object of the present invention to be able to install multiple floor, ceiling or wall board panels in a single plane parallel to the surface upon which the panels are being installed.

Other objects which become apparent from the following description of the present invention.

### SUMMARY OF THE INVENTION

In keeping with these objects and others which may become apparent, the floor, ceiling and wall panels of this invention are constructed of multiple board sheets, preferably three board sheets, of material bonded together using adhesive. The preferred material for each of the board sheets is plywood which may be of different or the same thickness for each. Other rigid durable sheet materials may be used such as flake board or composites incorporating wood materials. Materials such as foamed PVC can also be used for one or all three of the layers. The three pieces of plywood can be attached not only by adhesive, such as glue, but also by fasteners, such as nails, staples, etc. joining one or more of the three layers. The three pieces of plywood also can have plastic sheets inserted between the panels to reduce moisture between them. Also, the three layers can use different types of plywood. Optionally, each plywood board sheet layer can be treated differently to be water resistant, fire proof or insect resistant, etc. A typical fire resistant wood sealer such as described in U.S. Pat. No. 5,879,593 is mixed with the glue before the glue is applied between the layers. Optionally, waterproof glues, such as Gorilla® glue or Titebond® waterproof glue may be used. Fireproof glue, such as GB18583-2001/BS5852 manufactured by Stenzhen Gokangali Chemical Laboratory, Ltd. may be used and mixed with the glue. Insect resistant adhesives, such as manufactured by Henkel Adhesives can also be mixed with the glue and applied between the board layers.

In one embodiment for floor boards, all three board sheets are of identical size and shape (although the thickness may be different as desired). The shape, as described in the drawings, is either square or rectangular. (Other tiling shapes, such as hexagons or octagons, with straight sides may also be used.) By offsetting the middle board sheet layer so that two adjacent sides extend beyond the top and bottom board sheet layers which are in registration, a protruding tongue is developed on two adjacent sides while the opposite sides will have grooves. Thus such panels can be used to cover a large floor, ceiling or wall area using normal tongue-in-groove techniques by fitting the protruding tongues into the grooves of adjacent panels; a small amount of adhesive may be used in these fitted edges, but it is not essential in all applications. No routing of the edges is required to form the tongues or grooves.

In an alternate embodiment for walls and ceilings, the middle board sheet is smaller in size than the top and bottom board sheets which are in registration. The middle board sheet is centered within the top and bottom board sheets thus forming grooves on all four edges. To assemble these panels to cover a larger area, separate connecting slat tongues are used to connect the panels thereby acting as the tongues for a tongue-in-groove fit. By using a combination of short slat tongues and long slat tongues, large interconnected areas can be covered. By using slat tongues wider than the depth of two adjacent panel grooves, visible linear grooves the depth of the thickness of the top board sheet are formed between panels. They can be used to simulate a grout line in ceramic tile installations.

The top surface of each panel can be finished in a variety, of ways including grooving to simulate a parquet floor or patterns formed of veneers with oriented grain directions. It is also known that the pattern can be enhanced by one or more veneer pieces applied to the top of the assembled panels. Any appropriate sealant and/or stain can be used. Obviously the finish for a floor application would probably be different from that of a wall panel due to wear characteristics. Large inlay designs can be accommodated on several adjacent panels which are then assembled like a jigsaw puzzle to form a coherent design.

The tongue and the reciprocating groove are formed by attaching three panel board sheets, preferably plywood, together in a “sandwiched” overlying pattern. Because the plywood board sheets are flat, the tongues and corresponding grooves extend uni-directionally therefrom. They can be assembled by moving the tongue portions in one surface plane, such as horizontally for a floor or ceiling, and vertically for a wall. They do not need to be inserted at an angle and then locked in place by being moved in a non-planar fashion.

It is further noted that in the case the underlying wall to which the panels are being installed is warped and non-planar, an underlying layer of Sheetrock® wall board can be installed between the panels and underlying warped surface, to provide a relatively flat surface for installation of the array of panels.

In an alternate embodiment, the square or rectangular floor, wall, or ceiling panels are of different construction using a different fabrication method. The three-layer plus veneer construction of the embodiment above is replaced by a single solid layer with a veneer layer on top. The single layer is preferably a wood product such as plywood, high density fiberboard (HDF), or medium density fiberboard (MDF). The fabrication method involves the use of edge routing using a tongue cutter on one edge and a groove cutter on the opposite edge to form the edge shapes equivalent to those of the previous embodiment. If two routing heads are spaced apart the appropriate distance for a particular sized panel, a single pass can form a tongue on one edge and a groove on the opposite edge simultaneously. One cutter is spun clockwise while the second is spun counterclockwise to equalize the forces on the panel. Thus two passes are needed to form the edges of a panel. If the panel is square, the spacing of the two router heads need not be changed to form the edges orthogonal to the first ones formed. The veneer layer, which may be bamboo, birch, or other woods such as cherry wood, is adhesively bonded to the top surface as in the earlier embodiment.

It is further noted that the wood material can be as described in my co-pending patent application Ser. No. 12/380,928 filed Mar. 4, 2009. In that application, I describe a wood article of manufacture thus produced which can be a laminate panel of particle board of particular particle size and particle to glue ratios which provides a durable, lightweight and strong panel which gives the appearance of wood because its exterior veneer layer or layers are made from a thin wood veneer of approximately 0.35 to 0.70 millimeters in thickness. A preferable veneer thickness is 0.5 mm, although veneer thicknesses may range from 0.3 to 0.5 mm, although other suitable thicknesses may be used.

My co-pending application Ser. No. 12/380,928 describes that to keep the wood lightweight, the particles should be more than 1.0 mm and less than 5.0 mm in length, depth and width, preferably about 3.0 mm in length, depth and width so that they are small enough to have sufficient density for strength, but large enough to provide air spaces therebetween, to be filled by resin glue at a weight lighter than natural wood. The ratio of wood particles to glue should be preferably 100:10 to 100:12, i.e. 100 kg of raw wood particle material to mix with 10-12 kg of glue. The maximum permitted is 100:28, i.e. 100 kg wood particle to 28 gms glue. With the aforementioned parameters, the finished particle board density is 0.8 g/cm³. To keep the panels smooth and flat, sanding should be applied to keep height deviation within 0.1 mm. Also, to have sufficient glue without undue buildup or air bubbles, glue should be applied in the ratio of 320 g/m². To further keep the panels smooth, the thin veneer layers with glue are heat and pressure treated at 110 C and pressure of about 1 cm² per 7-8 kg. On the edges, veneer strips of about 1.5 cm in with and 0.5 to about 1 mm in thickness, with lengths of 1 meter or more, are applied at a pressure of approximately 200 pounds with a glue at approximately 200 degrees C. heat. For fireproofing, insect proofing or water proofing, a thin layer of Wood Fire Resisting Liquid is applied by putting the panels in a tank full of liquid of pressure more than 1, 2 Mp³P for at least 8 hours immersion, which will soak about 150 kg/cubic meter of product into the wood. At low ambient pressure, the wood must be soaked for at least 48 hours, as long as 80 to 100 kg/cubic meter is absorbed into the wood over the 48 hour period. Exterior brushing can also be applied in three layer coatings to a thickness of 0.5 kg/cubic meter. Although other fire resistant, water resistant and pest or mold resistant sealers can be applied, a typical fire resistant liquid wood sealer is described, for example, in U.S. Pat. No. 5,879,593, including a liquid composition of potassium hydroxide, sodium carbonate, silica and water.

My co-pending application Ser. No. 12/380,928 also describes a manufacturing system, method, and article of manufacture which is capable of producing a laminated product that has the appearance of traditional birch plywood. The laminated article of manufacture has an interior similar to that of particle board, but the laminated article of manufacture should has increased strength and lighter weight compared to that of other particle boards. Additionally, the laminated article of manufacture is capable of having at least one or a plurality of thin or ultra-thin veneers placed on opposing surfaces and opposing edges, and is capable of being painted. The laminated article of manufacture is capable of being manufactured from recycled biodegradable products. In the U.S. and Europe, the natural color of a natural wood surface having a clear coat with the texture of the wood showing through is highly desirable, especially that of Birch Wood grown in Northern Asia, (Northern China and Russia). Birch wood also has characteristics of surface hardness, beautiful texture, a minimum amount of scar marks, black lines, or mineral lines, does not easily break or change shape after having been cut in the format of veneer sheet (usually in the size of 4 feet by 8 feet, 0.3 mm to 0.5 mm in thickness), but these high quality veneers are becoming less and less available, because a 3 foot or larger diameter birch tree takes more than 60 years to grow, and there are only 3 to 5 sheets of 4 feet by 8 feet veneers in that tree. These 3 to 5 sheets of veneers, may be used on surfaces of 4 feet by 8 feet plywood, and used for the manufacture of 5 storage units for toys. One class room of furniture, however, needs at least 5 times of this amount of veneer, which means that a classroom's furniture needs five birch trees to manufacture the furniture.

My co-pending application Ser. No. 12/380,928 further describes a system which may be used instead of using birch veneer. Chinese Cottonwood (called Chinese Birch or Chinese beech) which grows on tree farms and takes approximately 7-10 years to grow, and which grows into a one and half foot diameter tree may be used. Veneers from these trees, however, have soft surfaces that may scratch easily. However, such veneers may be hardened by methods of the present invention, resulting in finished products that look substantially the same as Russian Birch, or other highly desired woods.

My co-pending application Ser. No. 12/380,928 also describes that by using the above wood materials and paint processes of the present invention, wood products can be made completely of recycled wood and veneers from fast growing Chinese trees, thus, minimizing impact to the environment.

My co-pending application Ser. No. 12/380,928 further describes a core of fresh or green wood and/or recycled wood products, which are processed down to a particle size of less than 5 mm, and preferably less than 3 mm, and bonded together with glue, opposing surface inner veneer bonded to opposing surfaces of the core with glue, opposing surface outer veneer bonded to opposing surface inner veneer with glue, opposing edge veneer bonded to opposing edges of the core with glue. Each of the veneers is preferably 0.5 mm thick, although suitable veneer thicknesses may range from 0.3 to 0.5 mm. The article of manufacture thus produced is a laminated wood product having a particle to glue ratios that provides a durable, lightweight, strong attractive product that gives the appearance of wood.

### BRIEF DESCRIPTION OF THE DRAWINGS

The present invention can best be understood in connection with the accompanying drawings. It is noted that the invention is not limited to the precise embodiments shown in drawings, in which:

FIG. 1 is a perspective exploded view of three board sheets forming a square panel with integral tongues on two edges and grooves on the other two.

FIG. 2 is a top view of the assembled panel of FIG. 1.

FIG. 3 is a top view of an alternate embodiment square panel with grooves on all four edges.

FIGS. 4A to 4F show a typical installation of the floor board panels, wherein:

FIG. 4A is a top plan view of a floor panel;

FIG. 4B is a front elevation view thereof;

FIG. 4BB is a close up partial detail view of the floor panel in FIG. 4B, taken along view circle line “4BB” of FIG. 4B;

FIG. 4C is a right side elevation view thereof;

FIG. 4D is a close detail view taken along view circle line 5D of FIG. 5C;

FIG. 4E is a top plan view during installation of an array of multiple panels; and

FIG. 4F is a top plan view after completion of installation of the array of multiple panels.

FIGS. 5A to 5R show the installation of a typical wall board, wherein:

FIG. 5A is a top plan view of a wall panel 10 of square configuration as in FIG. 3;

FIG. 5B is a front elevation view thereof;

FIG. 5C is a right side elevation view thereof;

FIG. 5D is a close up detail view taken along view circle line “5D” of FIG. 5C;

FIG. 5E is top plan view of a connecting slat for the panel of FIG. 16A;

FIG. 5F is front view thereof.

FIG. 5G is side view thereof;

FIG. 5GG is a close-up detail view of the connecting slat shown in FIG. 5G, taken along view circle line “GG” of FIG. 5G;

FIG. 5H is a top plan view of a rectangular wall panel;

FIG. 5I is a right side elevation view thereof;

FIG. 5J is a front elevation view thereof;

FIG. 5K is top plan view of a connecting slat for the panel of FIG. 16H;

FIG. 5L is front view thereof;

FIG. 5M is a top plan view of an array of wall panels during installation;

FIG. 5N is a top plan view of the array of wall panels also showing connecting slats;

FIG. 5O is a top plan view of a completed array of wall panels;

FIG. 5P is a top plan view of the array of connecting slat tongues for the wall panels;

FIG. 5Q is inverted cross sectional view viewed through view line “5Q-5Q” of FIG. 50;

FIG. 5R is a close-up detail view of taken along viewing circle line “5R” of FIG. 5Q;

FIGS. 6A-6R show the installation of a typical ceiling pattern, wherein:

FIG. 6A is a top plan view of a ceiling panel 100 of square configuration, similar to wall panel 10 as in FIG. 3;

FIG. 6B is a front elevation view thereof;

FIG. 6C is a right side elevation view thereof;

FIG. 6D is a close up detail view taken along view circle line “6D” of FIG. 6C;

FIG. 6E is top plan view of a short connecting slat for the panel of FIG. 6A;

FIG. 6F is front view thereof.

FIG. 6G is side view thereof;

FIG. 6H is a close up partial detail thereof, taken along view line circle “6H” of FIG. 6G;

FIG. 6I is a top plan view of a long rectangular slat for the ceiling panel;

FIG. 6J is a front view thereof;

FIG. 6K is a right side elevation view thereof;

FIG. “6L” is a close up detail thereof, taken along view line circle “6L” of FIG. 6K;

FIG. 6M is a top plan view of an array of ceiling panels and connecting slats during installation;

FIG. 6N is a top plan view of the array of ceiling panels further during installation;

FIG. 6O is a top plan view of the array of connecting slat tongues for the ceiling panels;

FIG. 6P is a top plan view of a section of panels installed on a ceiling;

FIG. 6Q is an inverted cross sectional view viewed through view line “6Q-6Q” of FIG. 6P;

FIG. 6R is a close-up detail view taken along view circle line “6R” of FIG. 6Q;

FIG. 7 is a top view of an alternate embodiment showing a square panel fabricated using a different method, wherein the base section is a single solid layer with a veneer layer bonded on top;

FIG. 8 is an edge view of the panel of FIG. 7;

FIG. 9 illustrates the fabrication method using two counter-rotating routing heads;

FIG. 9A is an enlarged close-up detail view of a modified bit with a textured cutting edge;

FIG. 9B is an enlarged close-up detail view of a modified panel tongue with surface texturization imparted by a bit with a textured cutting edge; and,

FIG. 9C is an enlarged close-up detail view of a of a modified panel groove with surface texturization imparted by a modified bit with a textured cutting edge.

### DETAILED DESCRIPTION OF THE INVENTION

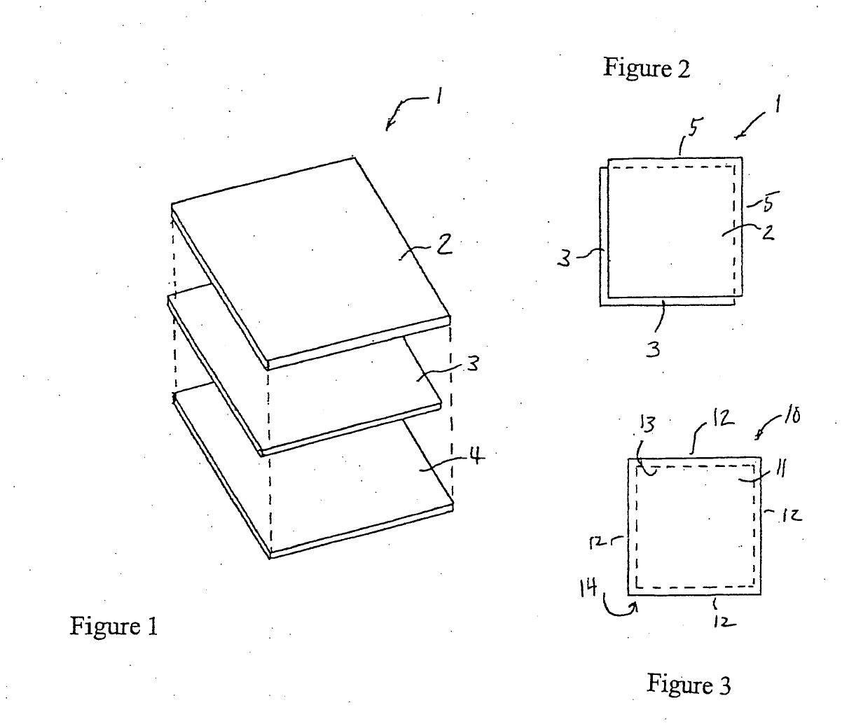

FIG. 1 shows three equal-sized board sheet layers, top 2, middle 3, and bottom 4 which will be adhesively bonded at the factory to form square panel 1 of the first embodiment with an offset middle layer. Each of the layers is preferably a board sheet of plywood. They can all be the same thickness, such as 6 mm, or the board sheets can be of different thickness as desired. These panels, of convenient size such as 12″ or 16″ can be used as floor tiles or for wall covering. While dimensions may vary, preferably square panels 1 have upper board sheets 2 and lower board sheets 4 which are 32 cm in length, sandwiching a mid board sheet 3 of 32 cm in length, which extends outward displaying a protruding tongue of 1.3 cm and a corresponding recess on an opposite side of 1.3 cm in depth. Each board sheet is preferably 6 mm, making panel 1 of three board sheets 2, 3 and 4 about 18 mm in thickness.

Each board sheet is preferably a rectangular cuboid, also called a rectangular parallelepiped, of which all faces are rectangular and where “rectangular” implies both rectangles and squares.

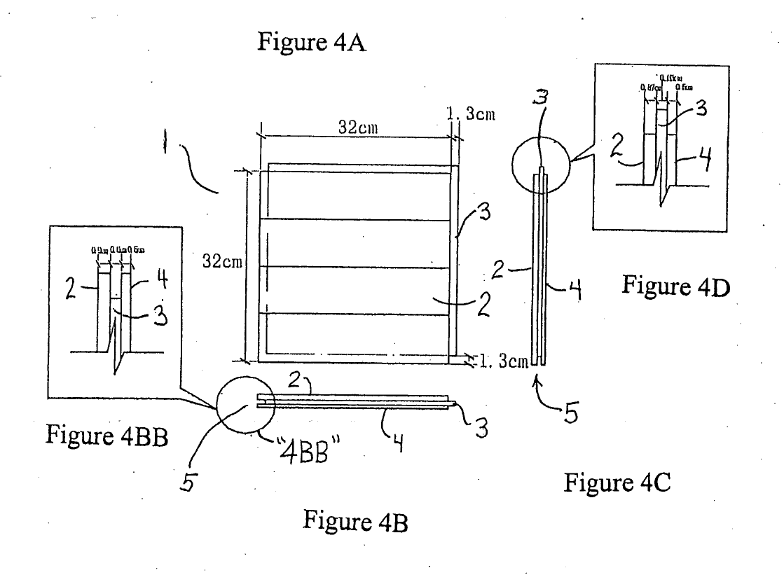

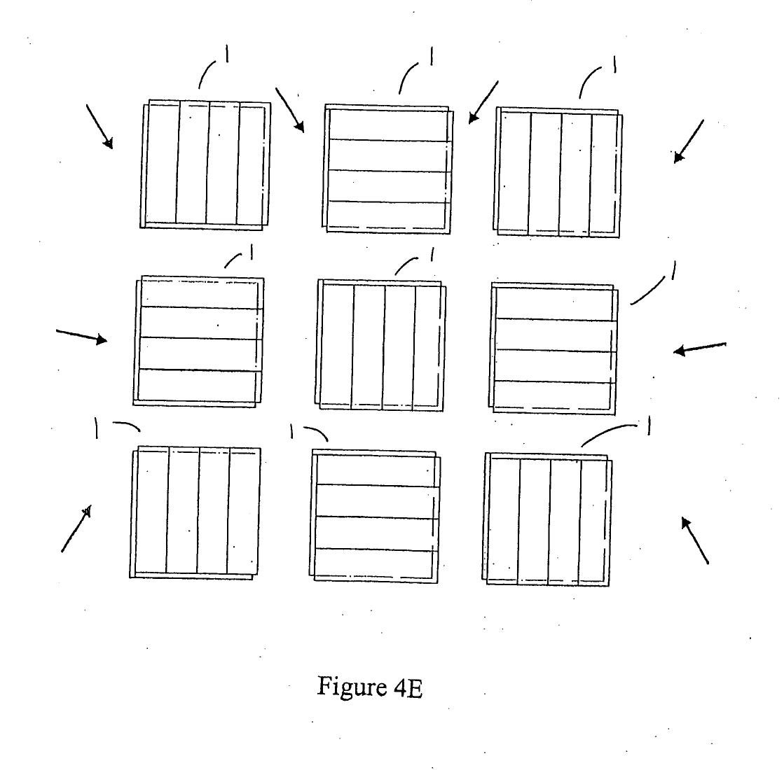

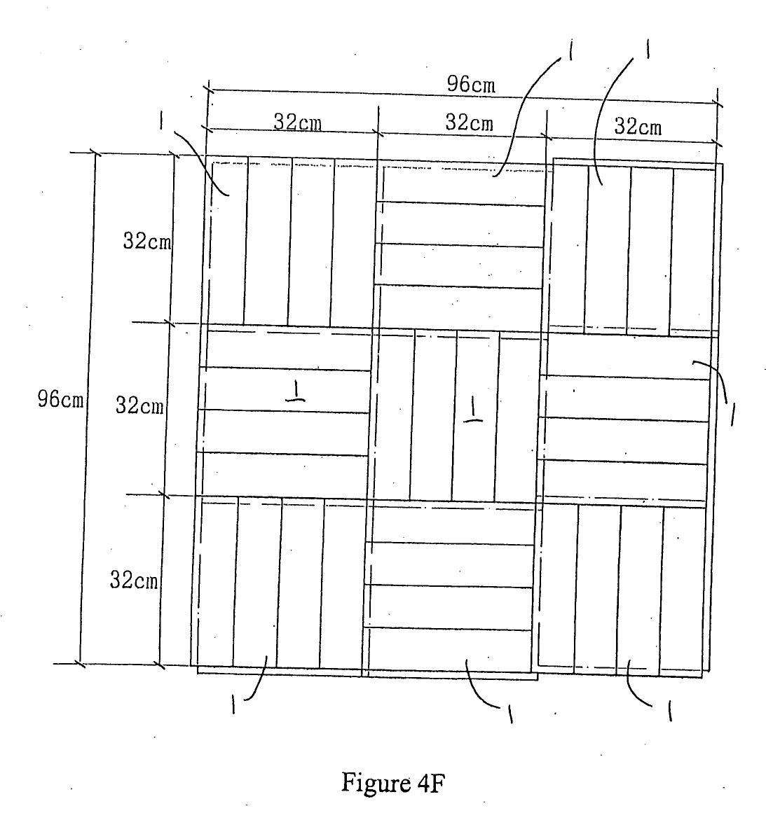

Each of the panels may be of one piece construction, plywood, or other suitable construction. A preferred embodiment of a floor panel system, as in FIG. 1 and FIGS. 4A-4F, constructed in accordance with the present invention comprises:

A floor panel system, comprising:
a plurality of substantially same size and shape wood floor panels 1 matingly and releasably adjoined one to the other,
each floor panel 1 of the plurality of substantially same size and shape wood floor panels 1 adapted to matingly and releasably adjoin to at least two other floor panels 1 of the plurality of substantially same size and shape wood floor panels 1,
   the each floor panel 1 having:
      opposing substantially rectangular cuboid shaped one piece wood board sheets 2 and 4,
         each opposing substantially rectangular cuboid shaped one piece wood board sheets 2 and 4 of the opposing substantially rectangular cuboid shaped one piece wood board sheets 2 and 4 comprising:
         substantially flat opposing first and second surfaces,
         opposing first edges substantially perpendicular to the substantially flat opposing first and second surfaces,
         opposing second edges substantially perpendicular to the substantially flat opposing first and second surfaces and substantially perpendicular to the substantially opposing first edges,
      a substantially centrally disposed substantially rectangular cuboid shaped one piece wood board sheet 3 having substantially the same size and shape as the each opposing substantially rectangular cuboid shaped one piece wood board sheet and having substantially flat opposing third surfaces, opposing third edges, and opposing fourth edges,
         the substantially flat opposing third surfaces bonded to each the substantially flat opposing second surface of the each opposing substantially rectangular cuboid shaped one piece wood board sheet and configured to have one of the opposing third edges and one of the opposing fourth edges extending from the each floor panel 1 forming substantially perpendicular adjacent tongues and substantially perpendicular adjacent grooves.

FIG. 2 shows a top view showing how the offset center board sheet 3 simultaneously forms two adjacent tongue edges as well as two opposite groove edges 5.

FIG. 3 is a top view of square panel 10 with smaller central board sheet 13, top board sheet 11, bottom board sheet 14 and grooves 12 on all four edges. External tongue slats are used with this embodiment.

Each of the panels may be of one piece construction, plywood, or other suitable construction. Each board sheet is preferably a rectangular cuboid, also called a rectangular parallelepiped, of which all faces are rectangular and where “rectangular” implies both rectangles and squares.

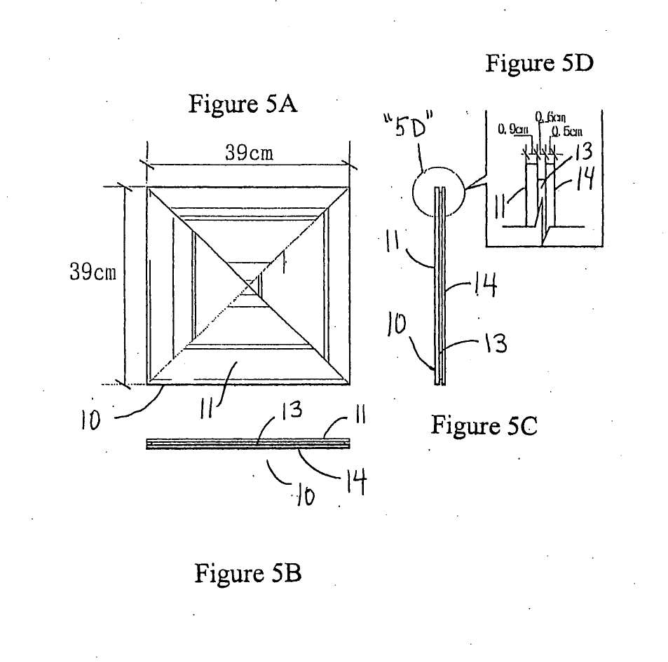

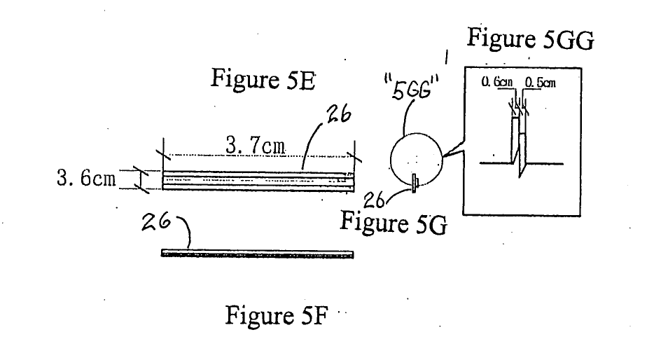

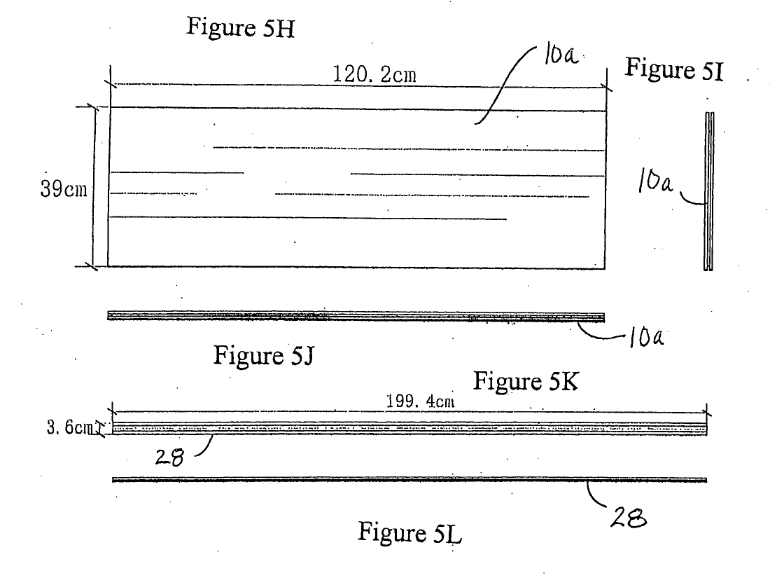

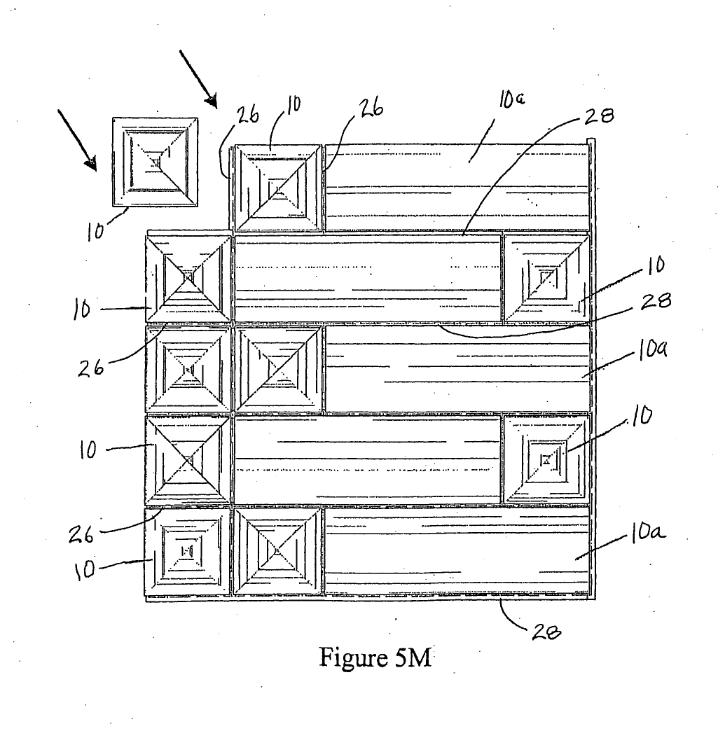

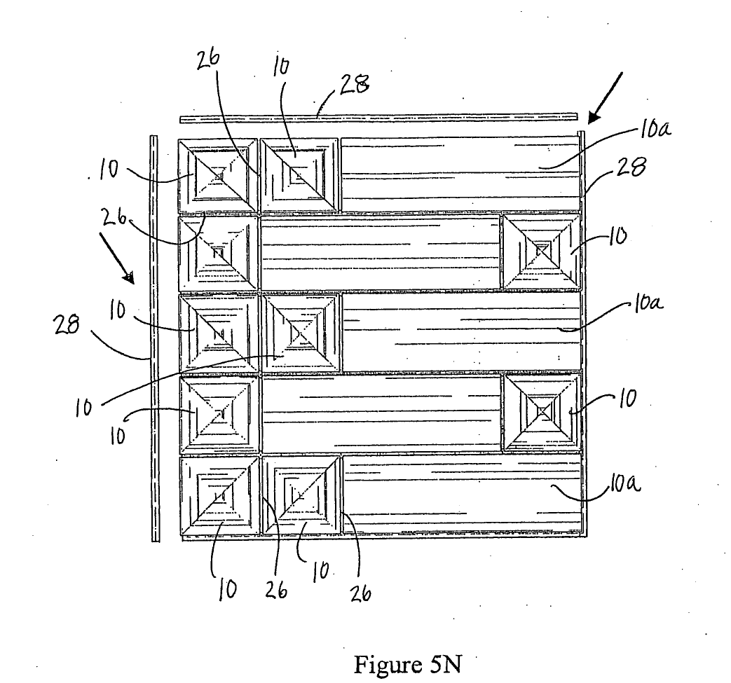

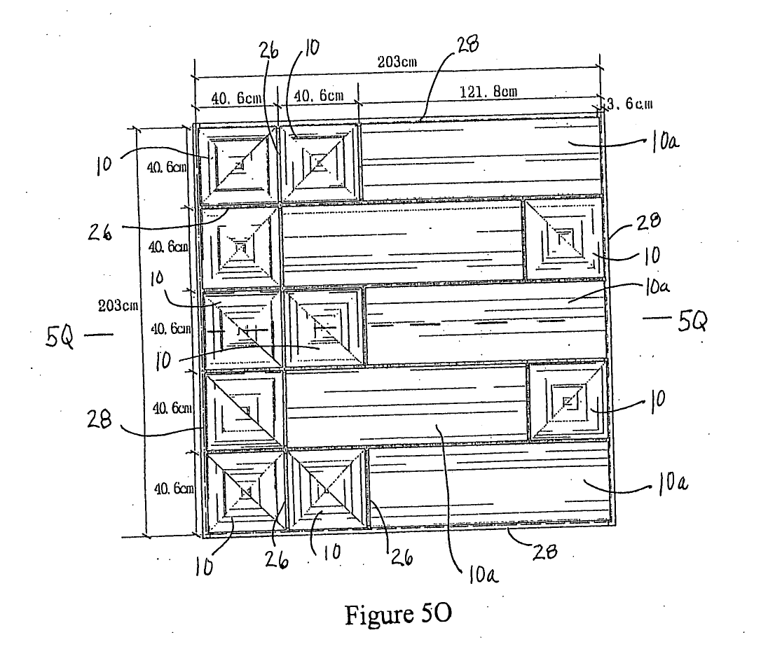

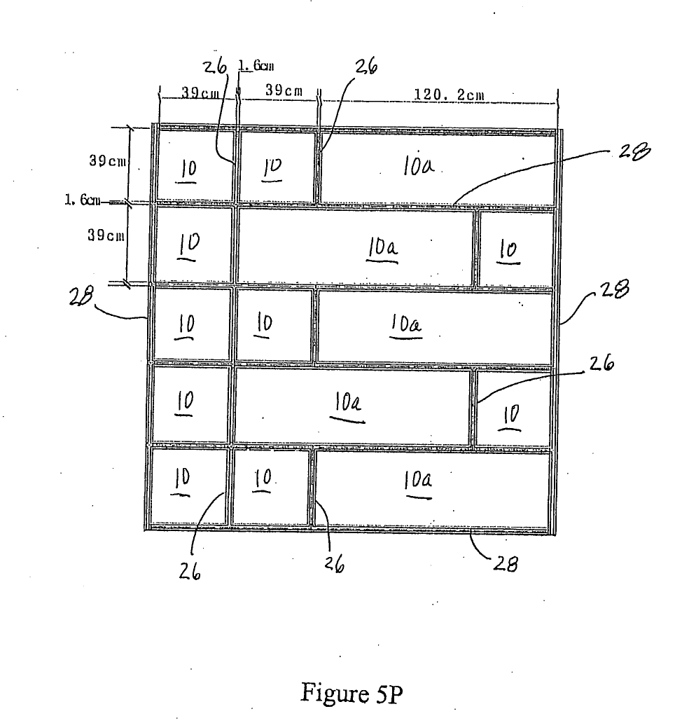

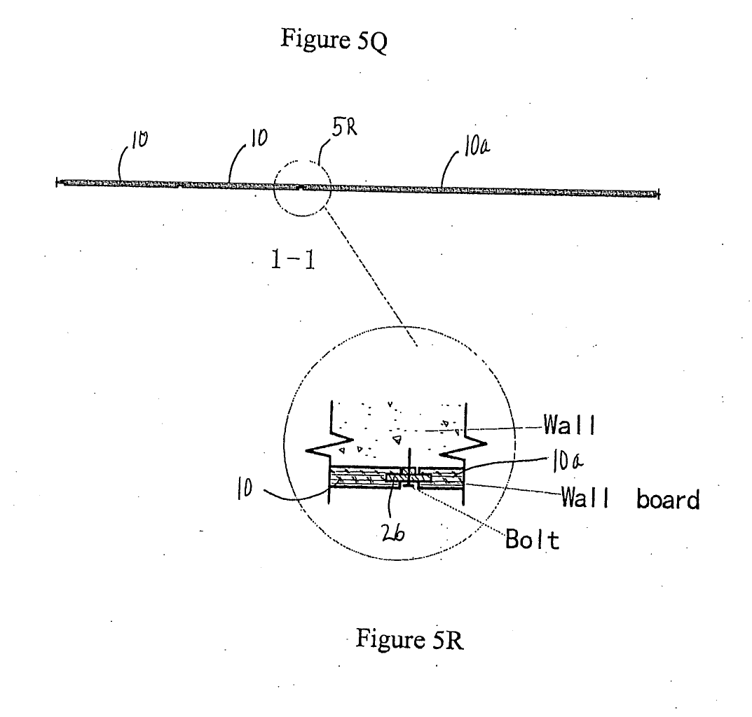

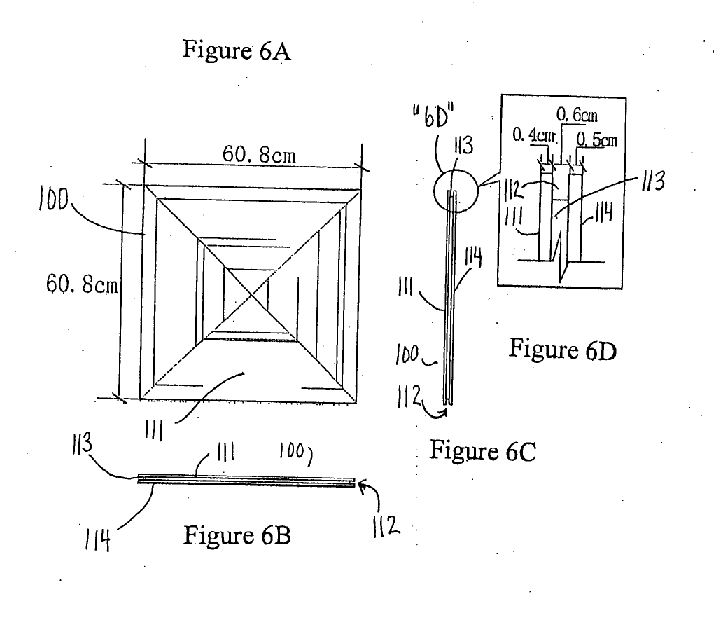

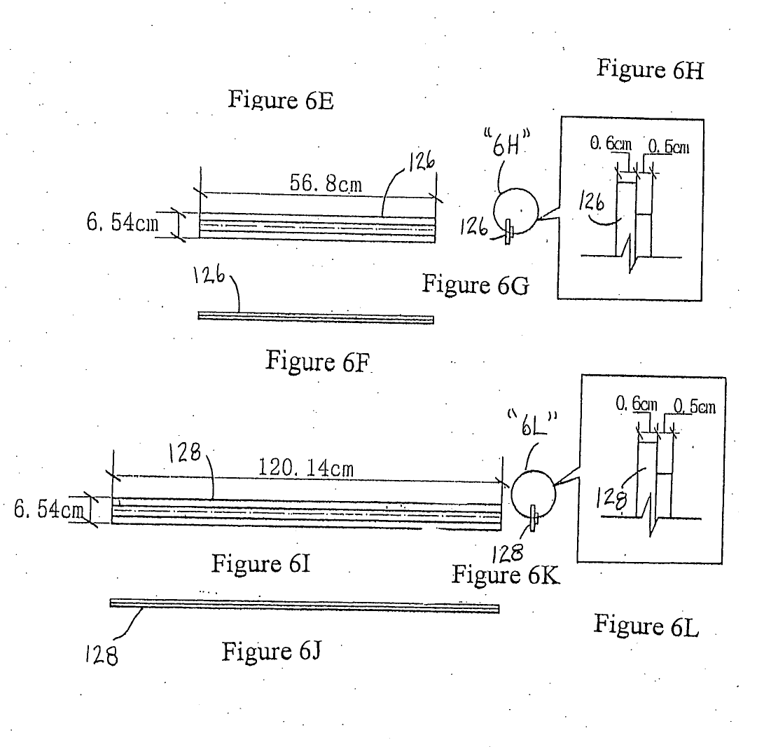

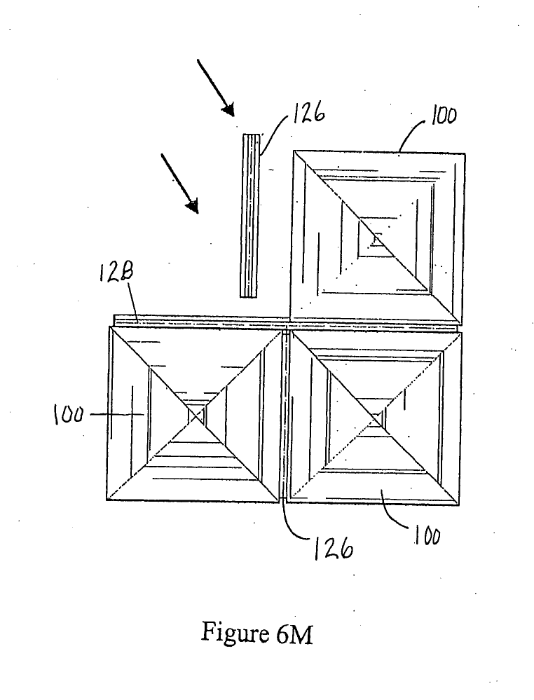

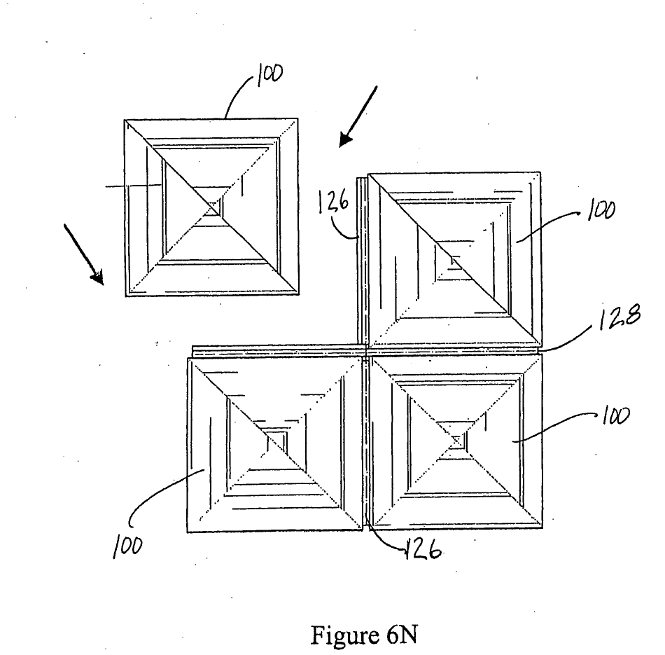

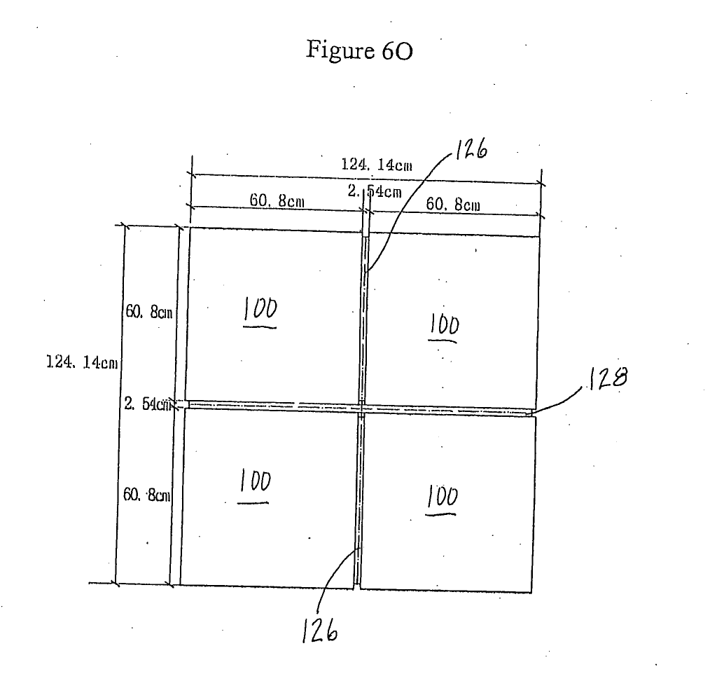

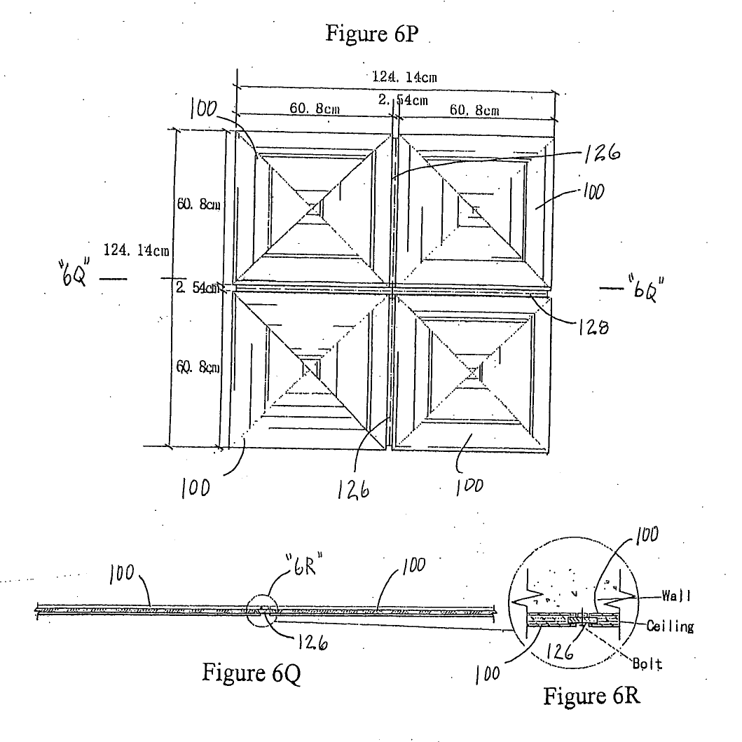

A preferred embodiment of a wall panel system, as in FIGS. 5A-5R constructed in accordance with the present invention, or a ceiling panel system, as in FIGS. 6A-6R, comprises:

a wall or ceiling panel system, comprising:
a plurality of substantially same size and shape wood wall or ceiling panels 10 or 100 panels 100 matingly and releasably adjoined one to the other,
each wall or ceiling panel 10 or 100 of the plurality of substantially same size and shape wood wall or ceiling panels 10 or 100 adapted to matingly and releasably adjoin to at least two other wall or ceiling panels 10 or 100 of the plurality of substantially same size and shape wood wall panels 10 or ceiling panels 100,
   the each wall panel 10 or ceiling panel 100 having:
      opposing substantially rectangular cuboid shaped one piece wood board sheets 11 and 14,
         each opposing substantially rectangular cuboid shaped one piece wood board sheet 11 and 14 of the opposing substantially rectangular cuboid shaped one piece wood board sheets 11 and 14 comprising:
         substantially flat opposing first and second surfaces,
         opposing first edges substantially perpendicular to the substantially flat opposing first and second surfaces,
         opposing second edges substantially perpendicular to the substantially flat opposing first and second surfaces and substantially perpendicular to the substantially opposing first edges,
      a substantially centrally disposed substantially rectangular cuboid shaped one piece wood board sheet 13 smaller than and having substantially the same shape as the each opposing substantially rectangular cuboid shaped one piece wood board sheets 11 and 14 and having substantially flat opposing third surfaces, opposing third edges, and opposing fourth edges,
         the substantially flat opposing third surfaces bonded to each the substantially flat opposing second surface of the each opposing substantially rectangular cuboid shaped one piece wood board sheet and sandwiched therebetween and configured to have the opposing third edges and the opposing fourth edges inwardly disposed within the each wall panel 10 forming opposing first grooves 12 and opposing second grooves 12 substantially perpendicular to the opposing first grooves, each the opposing first groove 12 of the opposing first grooves 12 and each the opposing second groove 12 of the opposing second grooves 12 having substantially the same depth;
      a plurality of spacer block standoffs 27 adapted to be fastened to a wall or ceiling;
      a plurality of first connecting slat tongues fastened to the plurality of standoffs 27,
         each first connecting slat tongue of the plurality of first connecting slat tongues adapted to be matingly and removably received within two adjacent abutting opposing first grooves of the opposing first grooves of two adjacent abutting the plurality of substantially same size and shape wood wall panels 10 or ceiling panels 100;
      a plurality of second connecting slat tongues 28,
         each second connecting slat tongue 28 of the plurality of second connecting slat tongues 28 adapted to be matingly and removably received within two adjacent substantially collinear second grooves 12 of the opposing second grooves 12 of the two adjacent abutting the plurality of substantially same size and shape wood wall panels 10 or ceiling panels 100 and substantially perpendicular to the plurality of first connecting slat tongues 26.

FIGS. 4A-4F show a typical installation of the array of floor board panels 1 with equal sized floor board panels 1 made of top panel board sheet 2, staggered mid panel board sheet 3 leaving two adjacent tongue portions and lower panel board sheet 4, wherein the staggered tongues engage grooves 5 forward between opposite edges of top panel board sheet 2 and lower panel board sheet 4 of an adjacent wall panel 10. While dimensions may vary, preferably square panels 1 have upper board sheets 2 and lower board sheets 4 which are 32 cm in length, sandwiching a mid sheet 3 of 32 cm in length, which extends outward displaying a protruding tongue of 1.3 cm and a corresponding recess on an opposite side of 1.3 cm in depth. Each board sheet is preferably 6 mm, making panel 1 of three board sheets 2, 3 and 4 about 18 mm in thickness. Floor board panels 1 are installed in a plane in the direction of the arrows indicated.

FIGS. 5A-5R show the installation of a typical wall board, where the panels are joined by short slat tongues 26 or long slat tongues 28 of FIG. 11, which are fastened by fasteners such as nails or screws through slats 26 or 28 and through standoff spacer blocks 27 to an underlying wall surface.

Each top and bottom board sheets 11 and 14 of square panel 10 of FIGS. 3 and 5A, is preferably 39 cm square, sandwiching smaller mid board sheet 13 of 37 cm in length therebetween. Connecting slat tongues 26 are preferably 37 cm in length and 3.6 cm in width and 0.7 cm in thickness, to fit in the grooves 12 on all sides of panel 10, wherein grooves 12 are 0.7 cm in width, to engage corresponding tongues of 0.7 cm in length.

Each top and bottom board sheets of rectangular panels 10a of FIG. 5H are also 39 cm in width, but 120.2 cm in length. Smaller mid board sheets are 3.6 cm in width and 199.4 cm in length, engaging corresponding grooves of 199.4 cm in length formed within rectangular panels 10a.

As shown in FIG. 50, when assembled in the vertical planar direction of the arrows, two square panels plus corresponding slat tongues each have a length of 40.6 cm×40.6 cm, combined with a long rectangle and corresponding slat tongue totaling 121.8 cm in length, for a combined assembly of 203 cm. Other panels may be added depending upon the wall size to be covered.

In an alternate embodiment, the wall panels can be installed on a ceiling, but preferably each square panel is 2 feet by 2 feet (60.96 cm×60.96 cm).

FIG. 6A is a top view of square ceiling panel 100 with smaller central board sheet 113, top board sheet 111, bottom board sheet 114 and grooves 112 on all four edges. External short connecting slat tongues 126 and long connecting slat tongue 128 of FIG. 6E through 6L are used with this embodiment to connect ceiling panels 100 to each other. Slat tongues 126 or 128 are inserted in place in a plane, in the direction of the arrows shown in FIG. 6M and FIG. 6N. The ceiling panels 100 are connected to a ceiling in a manner similar to that of wall panels in FIG. 5A through FIG. 5R, with fasteners, such as nails or screws, through slat tongues 126 or 128 and bracing standoff spacer blocks 127. While dimensions may vary, ceiling panels 100 are preferably 60.8 cm square (approximately two feet square). Mid panel board sheet 113 is about 56.8 cm square, revealing grooves on all four sides of about 2 cm in depth. Top board sheet 11 is about 0.4 cm in thickness, mid board sheet 113 is about 0.6 cm (as is groove 112 formed thereat) and bottom board sheet is about 0.5 cm in thickness. Short slat tongues 126 are about 5.8 cm×6.54 cm, and long slat tongues 128 are about 120.14 cm in length×6.54 corn in width. FIG. 6Q shows a section of a ceiling covered by a number of square ceiling panels 100. Ceiling board panels 1 are installed in a plane in the horizontal planar direction of the arrows indicated. The ceiling panels 100 can be also installed suspended in a drop ceiling configuration, where there are perpendicular connectors or frames spaced between the panels 100 and the ceiling surface above the panels.

In an alternate embodiment for floor panel 1, as previously shown in FIGS. 1, 2, and 4A-4F, while the three board sheets are substantially equal in thickness, in this alternate embodiment mid board sheets 3 forming tongues may be alternatively slightly thicker at the tongue end than at the end forming the groove between respective top and bottom board sheets 2 and 4, so that they form a tight fit when pushed into the respective grooves formed between top board sheet 2 and bottom board sheet. For example, the protruding end can be 0.63 cm but the groove can be 0.6 cm. Floor board panels 1 are installed in a plane in the direction of the arrows indicated, without any need to divert away from the horizontal planar direction of installation.

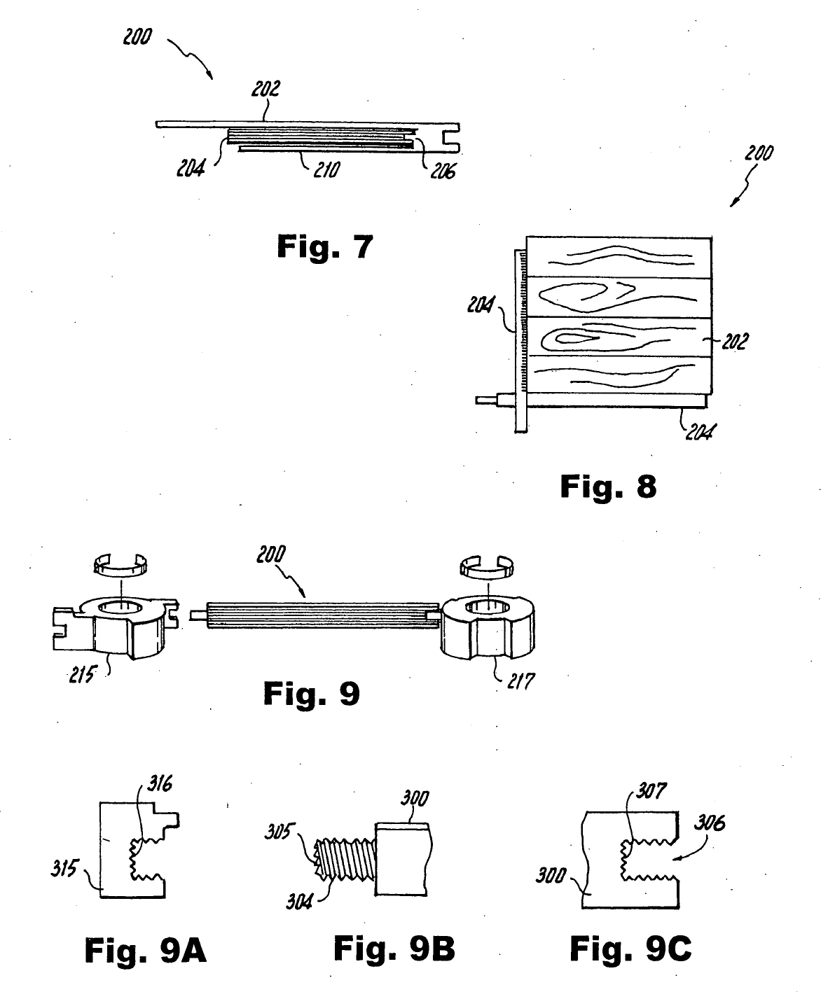

FIGS. 7-9 pertain to an alternate embodiment of panel of this invention which can be used for the same purposes as in FIGS. 4A-4F, 5A-5R, and 6A-6R. Although the panel is shown as a square panel, the fabrication method can also be extended to cover any rectangular panel as well.

FIG. 7 shows panel 200 with top veneer layer 202 which is adhesively bonded and protruding tongue edges 204. FIG. 8 is a side edge elevation of panel 200 showing solid base layer 210 and tongue 204 on one side with matching groove 206 on the opposite edge. Note that panel 200 has the same geometric edge features and veneer placement as the panel described if FIGS. 1-3. Base layer 210 is typically plywood, HDF, or MDF.

FIG. 9 illustrates the fabrication method whereby two opposite edges are formed simultaneously. Panel 200 is fed between two counter-rotating routing cutters, 215 and 217 cutting the tongue and groove respectively on opposite edges. The spacing of cutters 215 and 217 matches the desired panel dimensions.

Each panel can vary in size, but is preferably 30 cm by 30 cm in length and width. The solid supporting layer is preferably 2 cm in height and the top veneer is preferably 0.6 cm in height, although it can be varied up to preferably 0.8 or 1.0 cm in height. Preferably the total panel height is between about 2.6 cm to 3.0 cm in height. The tongue portion protrudes out about 1.5 cm in two directions and the respective grooves are each about 1.5 cm in depth.

FIGS. 9A, 9B and 9C show an alternate embodiment for a method of imparting extrications, such as serrations, threaded cuts and other textures surfaces, which can be used to provide a stronger gripping surface between the tongue of a panel with the groove of an adjacent panel.

For example, FIG. 9A shows a modified bit 315 with a textured cutting edge 316.

FIG. 9B shows a modified panel 300 with a tongue 304 having surface texturization 305 imparted by a bit 315 with a textured cutting edge 316.

FIG. 9C shows a modified panel 300′ with a groove 306 having surface texturization 307 imparted by a modified bit with a textured cutting edge.

In the foregoing description, certain terms and visual depictions are used to illustrate the preferred embodiment. However, no unnecessary limitations are to be construed by the terms used or illustrations depicted, beyond what is shown in the prior art, since the terms and illustrations are exemplary only, and are not meant to limit the scope of the present invention.

It is further known that other modifications may be made to the present invention, without departing the scope of the invention, as noted in the appended Claims.

I claim:

1. A method of making a set of interlocking floor or wall panels comprising the steps of providing a single solid layer with a veneer layer on top;
fabricating each respective panel by using edge routing using a tongue cutter on one edge and a groove cutter on the opposite edge of each respective panel to form the edge shapes of each said panel;
wherein, if two routing heads are spaced apart a predetermined appropriate distance for a particular sized panel, a single pass can form a tongue on one edge and a groove on the opposite edge simultaneously;
wherein further one of said cutters is spun clockwise while the second is spun counterclockwise to equalize the forces on each respective panel.

2. The method as in claim 1 further comprising the step of providing a veneer layer.

3. The method as in claim 2 wherein said veneer is selected from the group consisting of bamboo, birch, cherry wood, particle board, fiberboard and chip board.

4. The method as in claim 3 wherein said veneer is adhesively bonded to a top surface of each respective panel.

5. The method as in claim 1 wherein each said panel includes wood particles of at least 1.0 mm and less than 5.0 mm in length, depth and width.

6. The method as in claim 1 wherein each said panel includes wood particles of about 3.0 mm in length, depth and width wherein said particles are small enough to have sufficient density for strength, but large enough to provide air spaces therebetween, to be filled by resin glue at a weight lighter than natural wood.

7. The method as in claim 1 wherein said single solid supporting layer is a wood product.

8. The method as in claim 1 wherein said single solid supporting layer is selected from the group consisting of plywood, high density fiberboard (HDF), medium density fiberboard (MDF) or particle board.

9. The method as in claim 1 further providing the step of imparting texturizations to respective reciprocating surfaces of said tongue and said groove.
